(19) United States
(12) Patent Application Publication
(10) Pub. No.: US 2004/0013760 A1
(43) Pub. Date: Jan. 22, 2004

(54) Vertical hopper for producing boards consisting of derived timber products

(76) Inventors: Matthias Graf, Bretten (DE); Lutz Wolf, Darmstadt (DE); Guenter Natus, Muehltal (DE); Karl-Heinz Koehler, Hanau (DE)

Correspondence Address: FASSE PATENT ATTORNEYS, P.A., P.O. BOX 726, HAMPDEN, ME, 04444-0726, US

(21) Appl. No.: 10/399,351

(22) PCT Filed: Oct. 12, 2001
(86) PCT No.: PCT/EP01/11829

(30) Foreign Application Priority Data
Oct. 12, 2000 (DE) 100504701

(51) Int. Cl. A23P 1/00

(52) U.S. Cl. 425/371

(57) ABSTRACT

The invention relates to a vertical dosing hopper for producing wood material panels or board sheets, which is arranged above a spreading head for glued wood particles, and in which the particle supply reserve is provided essentially in a vertical direction. In this context, the wood particles are conveyed essentially from the top toward the bottom to a discharge device (18, 48). The invention is characterized in that the hopper is provided for elongated flat wood particles, wood strands (strands) for producing panels or board sheets with oriented wood strands (OSB, LSL). Thereby, the supply reserve space comprises at least one vertical conveying shaft (13), in which the elongated flat wood strands are continuously conveyed to a discharge device (18, 48). In this context, the conveying shaft consists essentially of at least two parallel and vertical oppositely-facing conveyor belts (14, 15, 46, 47), which extend over the entire hopper width.

The invention relates to a vertical hopper for producing wood material panels according to the preamble of the Patent claim 1.

In the production of chip panels, fiber panels, OSB panels, LSL panels and other wood material panels or sheets, dosing hoppers are connected before or upstream of the actual spreading elements. In this context, one generally understands OSB (oriented structural board) and LSL (laminated strands lumber) to refer to the technology of the chip-oriented production of structural chip panels with higher strength values. The elongated chips or wood strands (strands) used for this purpose in the ideal case comprise a length-width ratio of 10:1. In this context, the elongated wood strands usually have lengths of 80 to 200 mm, a width of 10 to 40 mm, and a thickness of 0.4 to 1 mm. Also in the production of such chip-oriented panels (OSB, LSL), the dosing hoppers effect an evening-out of a mass variation over time of the wood strand flow. Simultaneously they are to make possible a continuous feeding or supplying of the spreading heads.

A vertical hopper for producing conventional chip panels is known from the technical reference book by Deppe/Ernst “Taschenbuch der Spanplattentechnik” (Pocketbook of Chip Panel Technology), 3^{rd} Edition 1991, page 154 and 155. This vertical hopper is fed at the top with glued chips, which are moved downwardly in the hopper due to their gravitational force, and which, at the hopper floor, are moved into the spreading head by discharge rolls. Such vertical hoppers have the disadvantage, that they non-uniformly compress or compact the chip goods depending on the filling height, and therefore lead to a non-uniform discharge flow. Moreover, such vertical hoppers apparently also have a tendency toward bridge building, which very often causes a fluctuating discharge flow.

Moreover, a horizontal hopper is also known from the Deppe/Ernst page 155, wherein the material flow is fed in at the top via a helical screw conveyor. Through an oscillating, swinging or sluing process, the helical screw conveyor distributes the chips over the entire hopper width. At the hopper floor, there is provided a floor belt, onto which the chips are deposited, and which conveys the entire deposited chip layer slowly to a discharge opening. In order that the most uniform quantity possible is discharged into the spreading head, a reverse or return combing device is provided at the top in the hopper, by which a constant filling height is achieved. Discharge rolls are arranged above the discharge opening over the entire bulk bed height, which mill or till off the chips supplied by the floor belt and convey these chips into the discharge opening to the spreading head. In the production of panels or board sheets (OSB, LSL) of oriented wood strands, such a horizontal dosing hopper has the disadvantage, that the elongated wood chips are partially destroyed by the reverse or return combing device, whereby the strength of the panels (OSB, LSL) to be produced of oriented chips suffers.

Therefore, it is the underlying object of the invention to provide a dosing hopper for producing wood material panels or board sheets (OSB, LSL) of oriented wood strands (strands), which avoids the above mentioned disadvantages and ensures a substantially non-destructive intermediate storage and discharge of the elongated flat wood strands.

This object is achieved by the invention recited in the Patent claim 1. Further developments and advantageous example embodiments are recited in the dependent claims.

The invention has the advantage that no turning over of the material takes place in the dosing hopper due to the vertical conveying shaft, so that a gentle protective material flow and the oriented in-feed of the elongated wood strands is maintained in the hopper. Advantageously, the vertical conveying path section simultaneously also forms a material supply or reserve and makes possible a controlled uniform discharge, whereby the panel quality of the OSB or LSL panels to be produced can be improved.

In a particular embodiment of the invention, in which the conveying path section or the conveying shaft is embodied as a converging, clamping or pinching path section, a sliding-through is advantageously prevented even with a loose bulk filling, and simultaneously a secure entraining or carrying-along of the material flow located in the conveying path section is ensured.

In a further particular embodiment of the invention, in which in addition to the vertical- still further a horizontal conveying path section or a conveying shaft is provided, a pinch-free uniform discharge is advantageously made possible, because a loosened material flow arises in the horizontal conveying path section due to the deflection. Thereby, a substantial maintaining of the bulk material structure is simultaneously also possible, since no significant material turn-over occurs also in the horizontal conveying path section, whereby advantageously also the fines proportion is not increased. The horizontal conveying path section simultaneously also has the advantage, that in the start-up operation, the material to be filled-in cannot directly slide through into the spreading head, but instead first fills up the supply or reserve in the horizontal part, and is only carried out into the spreading head upon starting the operation of the horizontal- and vertical conveying path section.

The invention is described in further detail in connection with an example embodiment, which is shown in the drawing. It is shown by:

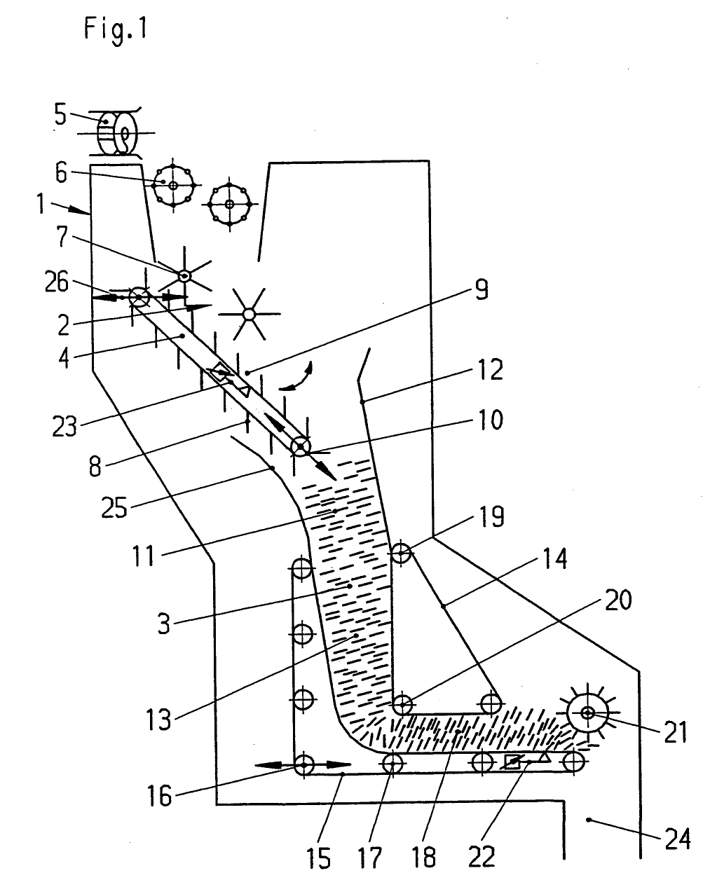

FIG. 1: a vertical hopper with a vertical and a horizontal conveying path section, and

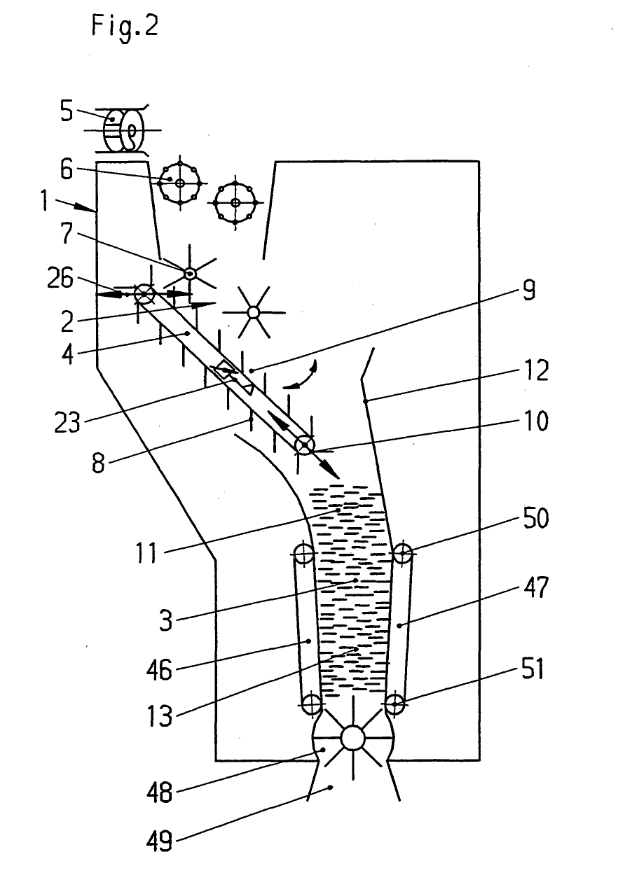

FIG. 2: a vertical hopper with a vertical conveying path section and a bucket wheel sluice.

In FIG. 1 of the drawing, a vertical hopper 1 is schematically illustrated, which consists of a vertical rigid filling shaft or chute 11, a vertical conveying shaft or chute 13, and a horizontal conveying shaft or chute 18, above which a feed device 2 is arranged.

In the production of OSB or LSL panels or board sheets, glued elongated flat wood chips or strands (strands) with a length of 80 to 200 mm, a width of 10 to 40 mm, and a thickness of 0.4 to 1 mm are processed to form wood material panels. These wood strands are supplied via a helical screw conveyor 5 from a gluing mixer to the dosing hopper 1. The wood strands thereby come continuously out of the trough of the helical screw conveyor 5 in an unordered manner, and are to be spread onto a forming belt to form an oriented fleece, without damage to the extent possible. Namely, due to the damage of the elongated wood strands, the bending strength would be impaired or the thereby arising increased proportion of fines would have to be additionally separated. For this reason, the invention proposes a dosing hopper 1 without a mixing or reverse combing apparatus and a conveying shaft or conveying path section, so that the elongated wood strands, to the extent possible, are not turned-over in the dosing hopper 1, and therefore are easily loosenable or separable and uniformly dischargeable.

The elongated wood strands are first deposited out of the trough of a helical screw conveyor 5 above the dosing hopper 1, onto two or more break-up rolls 6, which are to separate or break-up any possible occurring clumps or entanglements. For this purpose, preferably coarse-meshed cage rolls or spike rolls with few elastic spikes are provided, through which the loose wood strands can fall through nearly without any braking and free of damage.

At least two orienting rolls 7 are provided below the break-up rolls 6. The elongated wood strands glide into the slits of the orienting rolls 7 perpendicularly to the conveying direction. In this context, the orienting rolls 7 consist of a continuous through-going drive shaft, around which crosswise plates are provided and arranged in a star-like manner. Thereby, the spacing distances between the crosswise plates represent tapering slits, which are only so wide that the strands can glide thereinto only in a crosswise orientation. The orienting rolls 7 could, however, also be arranged in the conveying direction, so that the elongated wood strands would be oriented lengthwise. For the lengthwise orientation, however, disk rolls are also utilizable, through the slits of which the elongated wood strands would be directed in the lengthwise direction.

An oscillating conveyor belt 4 is arranged as an oscillating conveyor below the orienting rolls 7. The pre-oriented wood strands are deposited from the orienting rolls 7 onto the oscillating conveyor belt 4. Thereby, the conveyor belt is provided with crosswise webs 8 or crosswise plates, which form conveyor pockets 9 between the individual webs 8. Thereby, the spacing distances of the crosswise webs 8 or crosswise plates are dimensioned so that the wood strands can only be laid into the conveyor pockets 9 in their crosswise orientation, so that the crosswise orientation is maintained on the oscillating conveyor belt 4. With a lengthwise orientation, the conveyor belt could, however, also be provided with lengthwise webs, which take up the wood strands only in the lengthwise direction. A parallel conveyor could, however, also be provided below the orienting rolls 7. This parallel conveyor would be arranged to be slidable or pushable continuously back and forth perpendicularly to the hopper width and parallel to the conveying direction of the forming belt. In any event, then the break-up or loosening rolls 6 and the orienting rolls 7 would also have to be guidably movable in a following manner.

On its feed or take-up area, the oscillating conveyor belt 4 is supported in a manner so as to be swingable or oscillatable crosswise and horizontally, and the oscillating conveyor belt 4 is tilted downward at an angle relative to the horizontal in the conveying direction. Thereby, the output or discharge end of the oscillating conveyor belt 4 is arranged to extend or plunge into the vertical filling space 3. The oscillating conveyor belt 4 is connected with a known oscillating or swinging drive, which is not shown, and which continuously swings or oscillates the relatively narrow conveyor belt 4 of maximally 1 m width back and forth over the entire hopper width. Thereby the elongated wood strands are deposited or laid down layer-wise over the entire hopper width. In this context, the hopper width corresponds approximately to the spreading width, which generally amounts to 2 to 4 m.

For the continuous crosswise distribution of the wood strands in the vertical filling space 3, a belt weighing scale 23 is provided in the oscillating conveyor belt 4, and the conveying rate (t/h) of the conveyed wood strands is determined by the belt weighing scale 23. Thereby, the crosswise oriented wood strands are layable or depositable in a weight-dosed manner over the entire width of the dosing hopper 1 or the vertical filling space 3. In this context it is provided to lay down or deposit always the same weight quantity of wood strands over the entire hopper width, so that the vertical filling space 3 is uniformly filled. Therefore, a constant conveying rate (t/h) is prescribed, in connection with which, by a deviation from the rated or nominal weight, the belt speed is re-adjustable or regulatable in a following manner, whereby the swinging or oscillating speed remains constant. A prescribed conveying rate could, however, also be regulated by the swinging or oscillating speed. Since the oscillating conveyor belt 4 is sloped or inclined downwardly in the conveying direction, the downward inclination or slope of the conveyor belt 4 is detected by an inclination sensor or taken into account in a computerized manner with a constant inclination angle, in connection with the weight-dosed discharge. For this purpose, an evaluating device, not shown, is provided, by means of which both the belt loading as well as the belt speed is detected or acquired. In the event of a deviation from the prescribed conveying rate or from the rated or nominal weight, the belt speed of the conveyor belt 4 or the oscillating speed is correspondingly readjusted or regulated in a following manner.

While laying down or depositing the crosswise or lengthwise oriented wood strands in the vertical filling space 3, in order that the orientation is not lost, the spacing between the discharge location of the conveyor belt 4 from the depositing location in the vertical filling space 3 should not exceed a certain height spacing distance. For this reason it is provided that the oscillating conveyor belt 4 is adjustable in the conveying direction 10 so that it can reach or plunge more or less deeply into the vertical filling space 3. This can be carried out in a simple manner with a stroke or lift cylinder or a spindle drive. For this purpose, additional fill level sensors (not shown) are provided, which maintain a constant spacing distance from the wood strand surface in the vertical filling space 3 by means of a program controlled evaluating device.

In its filling area, the vertical filling space 3 consists of an upper filling shaft or chute 11, which consists of approximately parallel arranged rigid sidewalls 12, 25, which extend crosswise over the entire hopper width. These are secured at the end face on the hopper outer wall and form a rigidly surrounded or enclosed filling space 11. A vertical conveying shaft or chute 13 is arranged below this upper filling shaft 11. The conveying shaft 13 essentially consists of two vertically arranged discharge conveyor belts 14, 15, which undergo a horizontal deflection 16, 20 in their lower area or region. These belts 14, 15 extend over the entire hopper width, and, together with the end face side outer walls of the dosing hopper 1, form an enclosed conveying shaft 13, which continuously conveys the hopper contents to a discharge opening 24. The conveying shaft 13 could, however, also be formed of only one discharge conveyor belt 14 and a rigid sidewall arranged lying opposite thereto.

Regarding the two discharge belts 14, 15, these are respectively an endless belt, that is arranged between three deflection rolls 16, 19, 20, which are arranged approximately like the end points of a right-angled triangle. Thereby, the two conveyor belts 14, 15 respectively adjoin the bottom point of the side walls 12, 25 of the upper filling shaft 11, and thereby form its extension. Thereby, the two discharge belts 14, 15 are arranged so that they are provided with differing roll spacings. Thereby, the roll spacings are provided so that both a vertical conveying shaft 13 as well as a horizontal conveying shaft 18 are formed between the two conveyor belts 14, 15. In these deflected shafts 13, 18, the oriented wood strands are conveyed to a discharge opening 24.

In that context, the vertical conveying shaft 13 is embodied as a converging or squeezing or pinching path section, in that the shaft can be tapered downwardly on at least one inner side surface. This is achieved in that the lower discharge belt 15 lies only loosely on its support rolls 17, and the shaft width is adjustable with a horizontally adjustable tension roll 16. Due to the narrowing of the shaft width, the layers of the oriented wood strands are laterally squeezed in or pinched, so that these are carried along in the conveying direction by the motion of the discharge belts 14, 15. Thereby, it is simultaneously achieved that the individual layers in the lower region of the vertical conveying shaft 13 are not significantly compacted or compressed due to the filling height, so that an easily separatable bulk fill is maintained in the vertical shaft 13.

In the start-up operation, the vertical conveying shaft 13 is closable in the deflection area with the aid of the tension roll 16, so far that both discharge belts 14, 15 lie lightly against or in contact on one another with their inner walls. This prevents the occurrence that the wood strands to be newly filled-in can slide through to the discharge opening 24. Simultaneously, the vertical shaft 13 is reduced in size so far that the discharge height is only so large that an oriented laying-down or depositing remains assured in the vertical conveying shaft 13. While filling in the wood strands, the fill height is detected by the fill level sensors, and is provided to the evaluating device. This controls the following guidance or motion of the oscillating conveyor belt 4 in the conveying direction 10, so that the spacing distance to the fill level plane remains the same so long until a prescribed filling height is achieved. As soon as the converging, squeezing or pinching path section 13 is filled to the intended height, the belt tension is loosened by the adjustable tension roll 16, so much until a prescribed pinching effect is achieved. For this purpose, the lower shaft width can be enlarged so far that it corresponds to the shaft width of the upper filling shaft 11.

After filling up the converging, squeezing or pinching path section 13, the material conveying rate that is to be filled-in is increased so much until an intended total fill height is reached in the vertical filling space 3. This nominal or rated fill level height is detected by the fill level sensors, whereby upon reaching the nominal or rated fill level height, the in-feed conveying rate is regulated by the evaluating device so that the hopper 1 is always filled up to the nominal or rated fill level height. The fill level sensors can be arranged distributed on the end face side of the hopper so that they also detect the fill level height perpendicularly to the hopper width. For this purpose, the oscillating conveyor belt 4 can also be arranged to be slidably displaceable horizontally and perpendicularly 26 relative to the hopper width, and thus lengthwise relative to the forming belt, so that a constant filling height is also maintainable perpendicularly to the hopper width.

In the lower region of the converging, squeezing or pinching path section 13 or of the vertical conveying shaft 13, a deflection of the vertical discharge flow into a horizontal discharge flow takes place through the lower tension roll 16 of the lower discharge belt 15 and the upper tension roll 20 of the upper discharge belt 14. Thereby, a sliding-through of the vertical material flow to the discharge opening during the discharge operation is advantageously prevented. Simultaneously, a loosening of the compaction or compression effect is also achieved, so that a gentle protective uniform discharge into the spreading head is made possible. The vertical filling space 3 could, however, also be formed by two parallel oppositely arranged conveyor belts, that are directed toward two horizontal conveyor belts, which then form the horizontal filling shaft. A bucket wheel sluice or chute could, however, also be provided below the vertical filling space 13, through which the oriented wood strands are discharged into the spreading head according to the manner of the orienting rolls.

The horizontal discharge flow in the horizontal conveying shaft 18 in this regard represents a squeeze-free or pinch-free filling path section, which forms a horizontal supply reserve. This horizontal filling path section 18 predominantly serves for bringing about a uniform discharge behavior. This is predominantly achieved in that a loosening of a vertical layering is carried out by the deflection, so that a uniformly dischargeable material flow becomes adjusted or formed in the horizontal shaft 18.

The two discharge belts 14, 15 are regulatable in their belt speed. In this context, the belt speed of both discharge belts is regulated so that they ensure a constant-remaining discharge speed in the shafts 13, 18, so that the pre-orientation is not changed, and so that a material turning-over or tilling does not arise in the shafts 13, 18, to the extent possible. Preferably, a belt weighing scale 22 is still further provided at the belt end of the horizontal conveying shaft 18, by means of which belt weighing scale 22 the discharge quantity is regulatable via the discharge belt speed. Additionally, still further, a striking or strike-off roll 21 is provided at the belt end of the horizontal conveying shaft 18, which striking roll 21 combs off the oriented wood strands in a gentle protective manner into the discharge opening 24 to the spreading chamber. Thereby, the vertical hopper 1 ensures a gentle protective supplying or feeding and uniform weight-dosed discharge of the elongated wood strands, so that these can develop their maximum strength in the OSB or LSL panels that are to be spread-out, and are not impaired by the arising proportion of fines. The feed device 2 arranged in the vertical hopper 1 could, however, also be provided in a separate device component above the hopper housing, if this is possible and advantageously achievable for structural reasons.

In FIG. 2 of the drawing, a vertical hopper is schematically illustrated, in which only a vertical conveying shaft 13 with a bucket wheel sluice 48 is arranged below the filling shaft 11. The vertical hopper according to FIG. 2 of the drawing corresponds with the feed device 2 and the upper filling shaft 11 of the example embodiment according to FIG. 1 of the drawing, and is also provided with the same reference characters for the similar components. The conveying shaft 13 provided adjoining the upper filling shaft 11 consists of two conveyor belts 46, 47 lying opposite one another, which form the conveying shaft 13.

In that context, it concerns two similar conveyor belts with respectively two deflection rolls 50, 51 which extend over the entire shaft width. In this context, the conveyor belts 46, 47 are arranged so that the conveying shaft 13 tapers or narrows slightly downwardly, whereby the conveying shaft simultaneously also forms a converging, squeezing or pinching path section. Moreover, the width of the conveying shaft 13 essentially corresponds to the width of the filling shaft 11 lying thereabove. The conveyor belts 46, 47 could, however, also extend, in a lengthened form, to the oscillating conveyor belt 4 or a parallel conveyor, so that the rigid side walls would be replaced by the lengthened conveyor belts 46, 47. The conveying shaft 13 could, however, also be formed from only one conveyor belt 46, that is arranged lying opposite a rigid sidewall 12.

A bucket wheel sluice 48 is arranged below the conveying shaft 13 and is embodied according to the manner of the orienting rolls, and which discharges the wood strands in a dosed manner into the discharge opening 49 to the spreading head. In order to ensure a gentle protective material discharge, the speed in the conveying shaft 13 is tuned or adapted to the discharge rotational speed of the bucket wheel sluice 48, so that the crosswise or lengthwise oriented wood strands can glide free of damage into the conveying slits of the bucket wheel sluice 38. The bucket wheel sluice extends over the entire hopper width, so that a uniform dosed material discharge into the spreading head is ensured. Simultaneously, the bucket wheel sluice 48 makes sure that especially during the start-up operation, no larger discharge quantities can be emitted in an uncontrolled manner from the vertical hopper. With larger hopper widths (perpendicularly to the conveying direction), several bucket wheel sluices 48 or conveyor belts 46, 47 could also be arranged one behind another, in order to extend over the entire hopper width by complementing each other.

In a simplified embodiment, the material flow could be discharged directly out of the conveying shaft 13 without a bucket wheel sluice. Thereby, the conveying shaft 13 would be embodiable as a clamping or pinching path section, which would prevent a sliding-through of the wood strands. In order to ensure a prescribed squeezing or pinching effect also in the start-up operation, the two conveyor belts 46, 47 could be stressed or tensioned against one another by means of a spring tension. For this purpose, the conveyor belts could additionally still be equipped with spikes or ribs, which prevent a sliding-through, and ensure a good entraining or carrying effect of the wood strands.

In a further embodiment variation of the dosing hopper 1, it is provided that the vertical belts 14, 15, 46, 47 include pick-ups or transducers that detect the driven output moment, which is caused by the weight of the hopper contents. Through a calibration, with the aid of the pick-up signals, the hopper contents could be determined therefrom in an evaluating device. Simultaneously, the evaluating device could control the in-feed and/or discharge conveying rate by means of the hopper contents.

Incidentally, the invention is not limited only to the example embodiments illustrated here, but instead can also be realized by further types of embodiments.

1. Vertical dosing hopper for producing wood material panels, which is arranged above a spreading head for glued wood particles, whereby the particle supply reserve is provided essentially in a vertical direction and the wood particles come essentially from the top to the bottom to a discharge apparatus, characterized in that the hopper is provided for elongated flat wood particles or wood strands (strands) for producing panels with oriented wood strands (OSB, LSL), and comprises at least one vertical conveying shaft (13) as a supply reserve space, which continuously conveys the elongated flat wood strands to a discharge opening (24, 49).

2. Vertical dosing hopper according to claim 1, characterized in that a discharge apparatus is provided before the discharge opening, which discharge apparatus is embodied as a horizontal conveying path section or conveying shaft (18) or as a bucket wheel sluice (49).

3. Vertical dosing hopper according to claim 1 or claim 2, characterized in that a vertical filling space (3) is provided below a conveyor (4), and which consists of a vertical conveying shaft (13) or of an upper rigid filling shaft (11) and a lower conveying shaft (13).

4. Vertical dosing hopper according to one of the preceding claims, characterized in that the vertical conveying shaft (13) is formed of at least one or two vertical conveyor belts (14, 15).

5. Vertical dosing hopper according to one of the preceding claims, characterized in that the vertical conveyor belts (14, 15, 46, 47) are arranged parallel opposite one another or form a pinching path section that tapers downwardly, and which extend or extends over the entire hopper width.

6. Vertical dosing hopper according to one of the preceding claims, characterized in that the horizontal conveying shaft (18) or the horizontal conveying path section (18) is formed of at least one or two conveyor belts (14, 15) that are horizontal parallel opposite each other, and which extend over the entire hopper width.

7. Vertical dosing hopper according to one of the preceding claims, characterized in that the vertical conveying shaft (13) and the horizontal conveying shaft (18) is formed of at least two deflectedly arranged conveyor belts, whereby the deflection rolls of each conveyor belt are arranged like the end points of a triangle.

8. Vertical dosing hopper according to one of the preceding claims, characterized in that the lower sharply deflecting conveyor belt (15) is provided with adjustable deflection rolls (16), with the aid of which the belt tension and the pinching effect in the vertical conveying shaft (13) is adjustably settable.

9. Vertical dosing hopper according to one of the preceding claims, characterized in that a feed device (2) is provided above the conveying shaft (13), and includes orienting rolls (7) and an oscillating conveyor (4), with the aid of which the crosswise or lengthwise oriented wood strands can be brought into the supply reserve area.

10. Dosing hopper according to claim 1 or claim 2, characterized in that, an oscillating conveyor or a parallel conveyor is provided as a conveyor, which are embodied as belt conveyors (4), on the conveyor belt of which lengthwise or crosswise pockets for receiving crosswise or lengthwise oriented wood strands are provided.

11. Dosing hopper according to one of the preceding claims, characterized in that the oscillating conveyor (4) is arranged swingable or sluable horizontally and over the hopper width, and is movable back and forth continuously over the hopper width by a drive.

12. Dosing hopper according to one of the preceding claims, characterized in that the parallel conveyor is arranged slidable horizontally and parallel to the conveying direction (34), and is slidable back and forth continuously over the hopper width by one or more drives.

13. Dosing hopper according to one of the preceding claims, characterized in that the oscillating conveyor (4) or the parallel conveyor is arranged horizontally or sloping tilted downwardly in the conveying direction, and is adjustable in its slope and/or in the conveying direction (10).

14. Dosing hopper according to one of the preceding claims, characterized in that the pre-orienting apparatus (7) and/or the oscillating conveyor (4) is arranged in the hopper housing or above the housing.

15. Dosing hopper according to one of the preceding claims, characterized in that the oscillating conveyor (4) or the parallel conveyor is connected with a weighing device (23), which determines the weight of the discharged wood strands.

16. Dosing hopper according to one of the preceding claims, characterized in that the oscillating conveyor (4) or the parallel conveyor is embodied as a dosing belt weighing scale, which consists of a conveyor belt with an integrated weighing device, and which determines the conveying rate during a continuous oscillating process and compares the conveying rate with a prescribed conveying rate (t/h), and upon a deviation, regulates the belt speed or the oscillating speed so that a constant weight-wise material quantity with pre-oriented orientation is always discharged over the entire hopper width.

17. Dosing hopper according to one of the preceding claims, characterized in that a discharge belt weighing scale (22) is provided on the horizontal conveying shaft (18), with the aid of which the discharge conveying rate and/or the in-feed conveying rate is regulatable.

18. Dosing hopper according to one of the preceding claims, characterized in that fill level sensors are provided on the vertical filling space (3), which sensors detect the respective fill level heights.

19. Dosing hopper according to claim 18, characterized in that the fill level sensors are connected with an evaluating device, which is embodied so that, with the aid of the fill level signals, the conveyor (4) can be readjusted or guidedly moved horizontally (26) or at an angle relative to the horizontal (10) in a manner following the respective fill level height.

20. Dosing hopper according to claim 18 and 19, characterized in that the evaluating device is connected with the dosing belt weighing scale (4) and is embodied so that the in-feed conveying rate and/or the discharge conveying rate is regulatable with the aid of the fill level signals.

21. Dosing hopper according to one of the preceding claims, characterized in that the driven output moment of the vertical conveyor belts (14, 15, 46, 47) is detected and the fill weight is determinable therefrom by means of an evaluating device.

22. Dosing hopper according to claim 21, characterized in that the evaluating device is embodied so that the discharge conveying rate is controllable with the aid of the determined fill weight.

23. Dosing hopper according to one of the preceding claims, characterized in that the conveyor belt (15, 46) or the conveyor belts (14, 15, 46, 47) are embodied so that spikes, ribs or other means for material entrainment are provided on the endless belts.
